(19) United States
(12) Patent Application Publication
(10) Pub. No.: US 2026/0364682 A1
(43) Pub. Date: Nov. 19, 2026

(54) DEVICE AND METHOD FOR ADDITIVE MANUFACTURING WITH DUSTING OF A POWDER SPREADING CARRIAGE

(71) Applicant: AddUp, CEBAZAT (FR)

(72) Inventors: Benoît POURCHER, CEBAZAT (FR); Léopold BARRY, CEBAZAT (FR); Julien MARCER, CEBAZAT (FR); Julien CANO, CEBAZAT (FR)

(21) Appl. No.: 19/137,533

(22) PCT Filed: Dec. 14, 2023
(86) PCT No.: PCT/FR2023/052004

§ 371 Date: Jun. 10, 2025

(30) Foreign Application Priority Data
Dec. 14, 2022 (FR) 2213393

(51) Int. Cl. B22F 10/73; B29C 64/357; B33Y 40/00

(52) U.S. Cl. CPC B22F 10/73; B29C 64/357; B33Y 40/00

(57) ABSTRACT

An additive manufacturing device comprising an enclosure (3) and a conveyor configured to recirculate manufacturing powder, the enclosure comprising:
a work-holding platform,
a carriage configured to spread powder on top of the work-holding platform,
a dusting appliance included in the carriage and configured to trigger a jolt or a vibration in the carriage and remove powder from the carriage; and
an inlet of the conveyor
   the device being configured to feed removed powder from the carriage into the inlet of the conveyor, the inlet, being located between the work-holding platform and an end-of-travel position of the carriage.

### FIELD OF THE INVENTION

The invention relates to additive manufacturing which requires the additive manufacturing powder to be spread, for example by a powder spreading carriage.

### STATE OF THE ART

In additive manufacturing systems requiring powder spreading, it is necessary to use a system capable of transporting and spreading the powder, such as a powder spreading carriage, over the manufacturing area, such as a manufacturing work-holding platform.

Powder moved by the carriage, as well as unconsolidated powder at the end of the manufacturing process, can diffuse inside the enclosure. In particular, the spreading carriage may be covered with an undesirable layer of powder. As the spreading carriage moves over the work-holding platform, it produces the expected working surface of the powder layer before consolidation. The good condition of this work surface is essential to the quality of the manufactured part. There is a risk that some of the unwanted powder layer will fall from the carriage onto this work surface. The surface condition of the powder layer is then deteriorated just before consolidation, and there is a risk of poor quality in the manufactured part or object.

There is therefore a need for better control of the powder pollution generated in the powder spreading step.

### DISCLOSURE OF THE INVENTION

One aim of the invention is to better control the powder pollution generated in the powder spreading step.

The aim is achieved within the scope of the present invention by virtue of an additive manufacturing device comprising an enclosure and a conveyor configured to recycle manufacturing powder, the enclosure comprising:
a work-holding platform,
a carriage configured to spread powder over the work-holding platform,
a dusting appliance configured to remove powder from the carriage, and
a conveyor inlet,
   the device being configured to feed powder removed from the carriage into the conveyor inlet or into a storage area, the storage area extending inside the enclosure and comprising at least one wall distinct from the walls of the enclosure.

Such a device is advantageously and optionally completed by the following various features, taken alone or in combination:
the conveyor inlet or the storage area is located opposite an end-of-travel position of the carriage, the dusting appliance being configured to be triggered when the carriage is at the end of its travel so that the powder falls by gravity into the conveyor inlet or storage area;
the device is configured to feed powder removed from the carriage into the conveyor inlet, the inlet being located between the work-holding platform and an end-of-travel position of the carriage, the dusting appliance being mounted on the carriage and configured to be triggered when the carriage is level with the inlet
the device is configured to feed powder removed from the carriage into the conveyor inlet, the inlet being located between the work-holding platform and an end-of-travel position of the carriage, the device further comprising a displacement member distinct from the conveyor and configured to move powder removed from the carriage into the inlet;
the displacement member is a scraper mounted on the carriage and configured to be in an active configuration wherein the scraper is in contact with a bench in the enclosure and in a passive configuration wherein the scraper is located above the bench; and
the displacement member is a rotatable flap configured to be in an active configuration wherein the flap is inclined toward the conveyor inlet and in a passive configuration wherein the flap is horizontal.

The invention also relates to an additive manufacturing method comprising the following steps
by means of a carriage, spreading a production powder on a work-holding platform within an enclosure,
removing powder from the carriage, and
recycling the removed powder by a conveyor or storing the removed powder in a storage area, the storage area extending inside the enclosure and comprising at least one wall separate from the enclosure walls.

Such a method is advantageously and optionally completed by the following various features, taken alone or in combination:
powder removal is triggered after a step in which the carriage is moved to the end of its travel, so that when the powder is removed, the removed powder falls by gravity into the conveyor inlet or into the storage area;
powder removal is triggered after a step in which the carriage is moved vertically level with the conveyor inlet between the work-holding platform and a carriage end-of-travel position, so that during powder removal, the powder removed falls by gravity into the conveyor inlet;
the method comprises, after powder removal, a step of intermediately moving the removed powder into the conveyor inlet;
the intermediate movement is provided by a scraper mounted on the carriage and configured for contact with a bench; and
the intermediate movement is provided by a flap that can rotate and is configured to tilt toward the conveyor inlet.

### DESCRIPTION OF THE FIGURES

Further features and advantages of the invention will be apparent from the following description, which is purely illustrative and non-limiting, and should be read in conjunction with the appended drawings, in which:

FIGS. 1 to 7 are schematic representations of a detail of an additive manufacturing device according to different embodiments of the invention.

### DETAILED DESCRIPTION OF THE INVENTION

### Additive Manufacturing Device

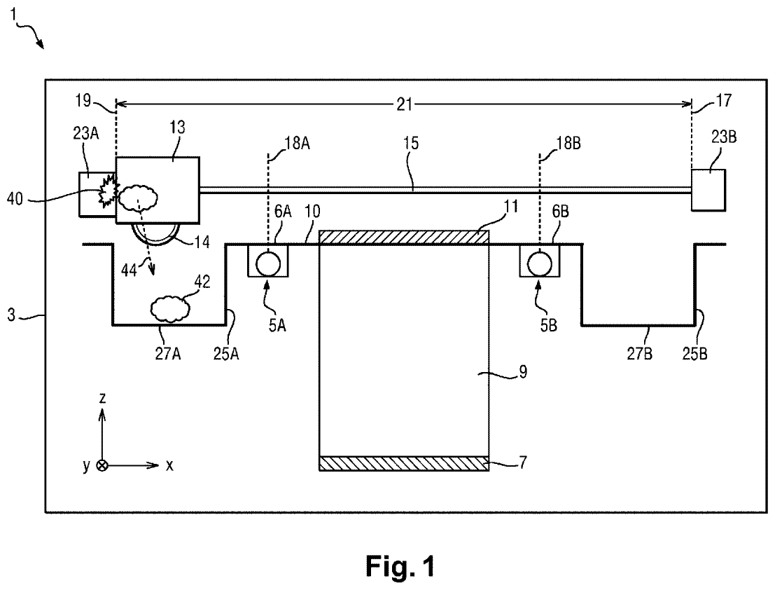

Referring to FIGS. 1 to 7, an additive manufacturing device 1 comprises an enclosure 3 wherein an object can be manufactured by consolidating an additive manufacturing powder.

The enclosure 3 comprises various walls that define a working chamber inside. The enclosure 3 is sealed. The gaseous environment inside the enclosure 3 can be controlled, in particular the enclosure 3 can be filled with an inert gas that does not alter the additive manufacturing powder.

The powder is placed on a work-holding platform 7 before being consolidated. The work-holding platform 7 has a horizontal upper surface. With reference to FIGS. 1 to 7, the x and y axes define a horizontal plane, while the z axis is oriented vertically upwards. The work-holding platform is rectangular, oriented along the x and y axes. The work-holding platform has a main length along the x axis and a transverse length along the y axis. The direction of the x axis is defined as the main direction and the direction of the y axis as the transverse direction.

The object is manufactured layer by layer: a first layer of powder spread over the work-holding platform is selectively consolidated, then a second layer of powder is spread over the first layer before being consolidated and fused to the previous layer. A number of layers 9 are stacked on top of the work-holding platform 7 as the manufacturing process progresses. The work-holding platform 7 can be moved in translation in a vertical direction. With each new layer spread, the work-holding platform 7 can move vertically downwards along the z axis by a distance corresponding to the thickness of a layer. In this way, the last layer spread, referenced 11 in the figures, is always at the same height in the enclosure 3.

The enclosure comprises a bench 10 that extends around the work-holding platform 7. The bench 10 is a single-piece part that surrounds the entire work-holding platform 7. The bench 10 vertically separates the production line above the bench 10 from the lower part of the production machine. The upper edge of the bench 10 defines a wall that seals the production line and the lower part from the production powder. Gas tightness can also be ensured. The bench 10 reduces the number of joints and/or gaskets required for sealing. The bench 10 defines a wall whose maximum vertical position is close to, or even coincides with, the vertical position of the last spread layer 11. In this way, the bench 10 and the last spread layer 11 form a continuous horizontal surface if there is no vertical gap between the bench 10 and the last spread layer 11, or quasi-continuous if there is a slight vertical gap between them.

The powder is fed into the enclosure 3 by a delivery system 5A, 5B. The system comprises, for example, two sliding trays that extend in the transverse direction, along the y axis, over the entire transverse length of the work-holding platform. The sliding trays can be moved in translation in the transverse direction and comprise an upper surface onto which a continuous bead of manufacturing powder is deposited. The two beads can thus be positioned in the main direction on both sides of the work-holding platform 7, with each bead extending over the entire transverse length of the work-holding platform. The delivery system 5A, 5B thus brings the powder close to the work-holding platform.

The sliding tray occupies a volume defined by a depression in the bench 10. The upper surface of the bench 10 has a recess wherein the sliding tray is housed. The upper surface on which the powder is placed has a vertical position that is close to, or even coincides with, the maximum vertical position of the bench 10. In this way, the upper surface of the sliding trays of the delivery system 5A, 5B and the bench 10 form a continuous or virtually continuous horizontal surface.

The delivery system 5A, 5B also comprises a recycling path that automatically recycles powder entering an inlet 6A, 6B of the system 5A, 5B. For example, the recycling path of the delivery system 5A, 5B comprises a gutter located below the inlet 6A, 6B, which can receive the powder, and an auger screw which can carry the powder received to a reservoir extending, for example, outside the enclosure, or to a recycling circuit, or to a suction and filtering system which returns the powder to a main hopper of the additive manufacturing device. This recycled powder can then be spread on the work-holding platform at a later date.

The delivery system 5A, 5B is configured to convey powder close to the work-holding platform 7, so that the sliding trays and inlets 6A and 6B are located close to the work-holding platform 7. In the main direction parallel to the x axis, the sliding trays and the inlets 6A and 6B have positions 18A 18B, which lie between the work-holding platform and the end-of-travel positions 17 and 19 of the carriage.

The additive manufacturing device 1 comprises a carriage 13 configured to spread powder on top of (or over) the work-holding platform 7. The carriage 13 is movably mounted inside the enclosure and moves in the main direction parallel to the x axis. More precisely, the carriage 13 can be moved in translation along a ramp 15 which is directed in the main direction. The carriage 13 is configured to move along a defined stroke 21 between a first end-of-travel position 17 and a second end-of-travel position 19. The stroke 21 corresponds to the length of the ramp 15 in the main direction.

The carriage 13 is configured to move over the work-holding platform 7 along the entire main length of the work-holding platform. The stroke 21 of the carriage covers the main length along the x axis of the work-holding platform 7.

The lower part of the carriage 13 comprises a member 14 configured to come into contact with the powder and spread it out in a horizontal plane. For example, the member can be a roller or a squeegee.

To this end, the carriage 13 and the member 14 each extend in the transverse direction over a length greater than or equal to the transverse length of the work-holding platform.

The carriage 13 is configured to move over the sliding trays of the delivery system 5A, 5B to distribute the powder over the work-holding platform 7.

The carriage 13 is configured to move continuously over the powder supply points and the work-holding platform. In other words, the carriage 13 is configured to move over the bench 10.

When the carriage is set in motion and comes into contact with the powder, it may become coated with an undesirable layer of powder. The device comprises a dusting appliance that is configured to remove at least some of the powder that thus accumulates on the carriage.

### Dusting Appliance

Different embodiments of this dusting appliance are possible.

Referring to FIGS. 1, 2 and 5, a first embodiment of the dusting appliance uses stops 23A and 23B on the carriage 13. The stops 23A and 23B are located at the ends of the ramp 15, so that when the carriage reaches the end of its travel, it is in contact with one of these stops. A dusting appliance can be created by applying a jolt 40 between the carriage and the stops 23A and 23B. In particular, the carriage can be propelled against the stop. In this first embodiment, the dusting appliance is fixedly mounted in the device 1. When the jolt 40 occurs, a quantity of powder 42 falls from the carriage 13 in the movement shown by arrow 44.

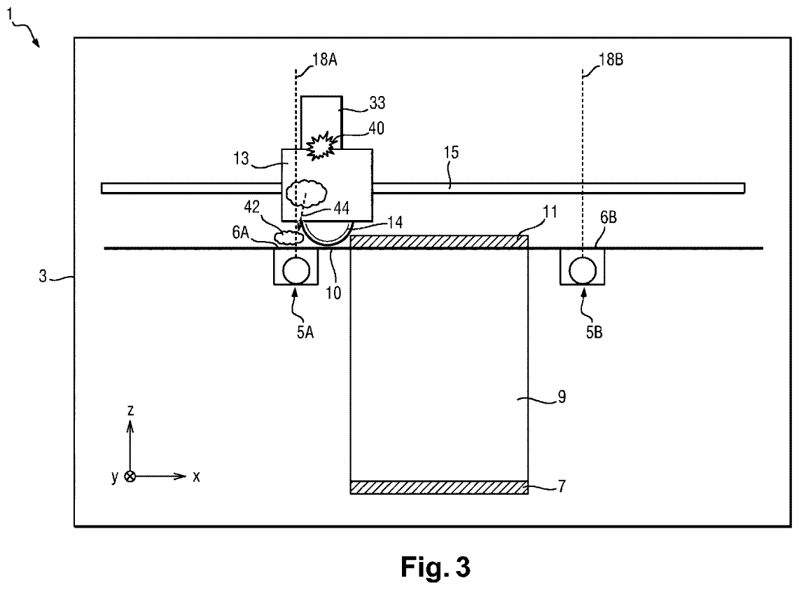

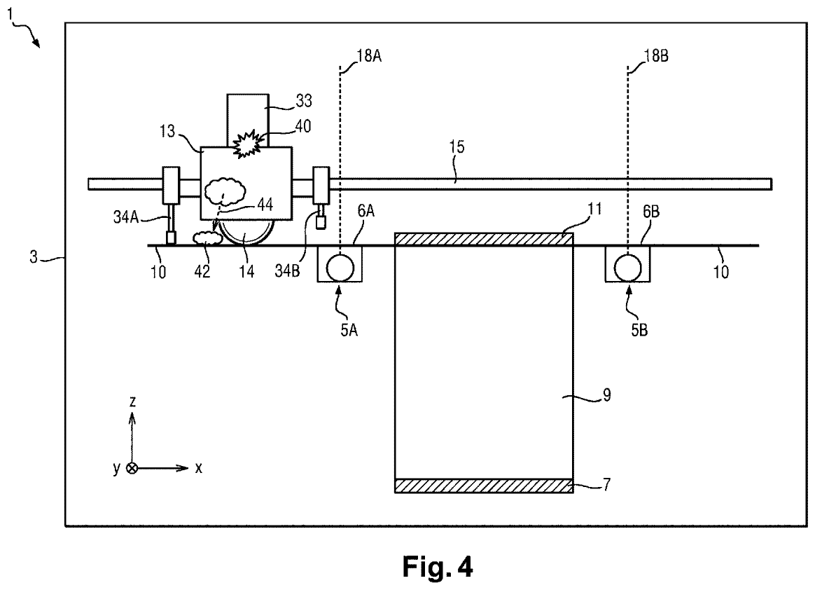

Referring to FIGS. 3 and 4, a second embodiment of the dusting appliance uses a dusting appliance 33 mounted on the carriage 13. The dusting appliance 33 then becomes part of the carriage 13 and moves along with the carriage 13. The dusting appliance 33 can be, for example, a striker comprising a spring which can be compressed under the action of a pressurized inert gas fed into a cylinder of the striker. When a trigger signal is received, the compressed inert gas can be released from the cylinder, releasing the spring which carries a part to strike the body of the carriage 13. Alternatively, the dusting appliance 33 can be a vibrating system which, on receiving a trigger signal, starts to oscillate, agitating the carriage to which the vibrating system is attached. The dusting appliance is configured to trigger a jolt or vibration in the carriage. The dusting appliance is an active component that is supplied with energy to deliver the jolt or vibration to the carriage. During the impact or vibration 40, a quantity of powder 42 falls from the carriage 13 in the movement shown by arrow 44. The quantity of powder 42 falling from the carriage 13 is referred to in the following as “removed powder”. The jolt or vibration can be triggered at will, so it is possible to choose the dusting location, that is to say where the powder is removed from the carriage.

### Delivery Points for Powder Removed From the Carriage

The device 1 is configured to feed the powder 42 removed from the carriage to one of the two locations presented below and corresponding to the following two options.

According to a first option, the powder removed from the carriage is fed into the storage area, the storage area extending inside the enclosure and comprising at least one wall distinct from the walls of the enclosure.

FIG. 1 shows this first option. In this first option, the device 1 comprises at least one of the two storage areas 25A, 25B. When the device 1 comprises the two storage areas, these are located in the main direction, parallel to the x axis, on both sides of the work-holding platform 7, advantageously symmetrically. A storage area 25A, 25B extends inside the enclosure 3. A storage area 25A, 25B is defined by walls 27A, 27B. These walls 27A, 27B are distinct from the walls of the enclosure 3. A storage area 25A, 25B defines a storage volume adapted to receive powder, the storage volume being integrally included in the working chamber defined by the enclosure 3. As shown, the storage areas can be recessed or depressed volumes defined in the bench 10. In other words, the upper surface of the bench 10 can present a recess or depression from its maximum vertical position. This recess corresponds to the walls 27A, 27B which extend downwards from the maximum vertical position of the bench 10. The recess defines a storage volume that lies below the maximum vertical position of the bench 10. In this case, the walls of the storage area are all below the maximum vertical position of the bench 10, and the storage area is open at the top. This opening allows the powder to be received. The storage volume can then be defined by the walls and a virtual closure given by the vertical position of the bench 10.

Advantageously, the storage volume is chosen to be greater than or equal to four liters.

According to a second option, the powder removed from the carriage is fed into the inlet of a conveyor configured to recycle manufacturing powder.

This conveyor is configured, for example, to receive the removed powder and convey it to the powder circulation system for spreading, so that the removed powder is spread again on the work-holding platform. The conveyor is configured to convey the powder received at the inlet so as to subsequently spread the powder on the work-holding platform. For example, the conveyor can carry the removed powder to a reservoir, or to a recycling circuit, or to a suction and filtering system that returns the powder to a main hopper of the additive manufacturing device.

In a first variant, the conveyor can be the recycling path of the delivery system 5A, 5B described above.

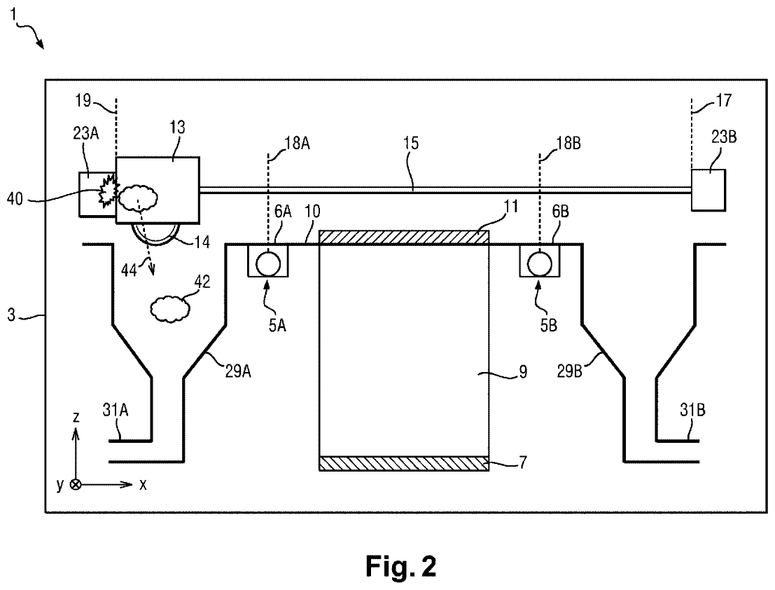

In a second variant shown in FIG. 2, the conveyor can be distinct from the recycling path of the delivery system 5A, 5B. The conveyor is then a recovery bin 29A, 29B connected to a powder suction system. The recovery bin 29A, 29B extends inside the enclosure 3. The recovery bin 29A, 29B is defined by walls distinct from the walls of the enclosure 3. The recovery bin 29A, 29B defines a volume suitable for receiving powder, entirely within the working chamber defined by the enclosure 3. As shown, the recovery bin can define a recessed or depressed volume in the bench 10. In other words, the walls of the bin extend downwards from the maximum vertical position of the bench and define a volume that lies below this maximum vertical position of the bench 10. In this case, the recovery bin has walls all below the vertical position of the bench 10 and is open at the top. This opening allows the powder to be received. The reservation bin comprises a hole at its lowest point, at the bottom of the bin, which is connected via a duct 31A, 31B to a powder suction system. The powder suction system is configured to send the powder received in the recovery bin via the orifice and the duct 31A, 31B to a reservoir, or to a recycling circuit or to the powder circulation system for spreading, so that the removed powder is spread again on the work-holding platform.

As shown in FIG. 2, the device 1 can comprise two conveyors located in the main direction, parallel to the x axis, on both sides of the work-holding platform 7, advantageously symmetrically.

In common with the first and second options described above, the device can be configured in the following first configuration: the conveyor inlet or the storage area is located opposite an end-of-travel position of the carriage, the dusting appliance being configured to be triggered when the carriage is at the end of its travel so that the powder falls by gravity into the conveyor inlet or storage area.

This first configuration is shown in FIGS. 1 and 2.

The end-of-travel positions 17 and 19 have already been described. When the carriage reaches one of these positions, and is therefore in contact with one of the stops 23A, 23B, then the conveyor inlet or storage area is located vertically below the carriage 13.

In this first configuration, the conveyor can be a recovery bin 29A, 29B connected to a powder suction system. Conversely, the conveyor cannot be the recycling path of the delivery system 5A, 5B, as the inlets 6A, 6B have positions 18A, 18B different from the end-of-travel positions 17 and 19 of the carriage.

The various types of dusting appliance described above are compatible with this first configuration.

In connection with the second option shown, the device can be configured for the following second configuration: the conveyor inlet is located between the work-holding platform and an end-of-travel position of the carriage, the dusting appliance being mounted on the carriage and configured to be triggered when the carriage is in line with the inlet. In this way, the dusting appliance dusts the carriage when it is in line with the inlet.

This second configuration is shown in FIG. 3.

In this second configuration, the conveyor can be the recycling path of the delivery system 5A, 5B, as the inlets 6A, 6B have positions 18A, 18B different from the end-of-travel positions 17 and 19 of the carriage 13.

When the carriage 13 is in line with the conveyor inlet, the carriage 13 is at a distance from the stops 23A, 23B, so that the dusting appliance that uses the stops 23A and 23B of the carriage 13 cannot be used to dust the carriage 13. The second embodiment of the dusting appliance mounted on the carriage 13 is therefore used in this second configuration.

### Displacement Member

Also in connection with the second option shown, the device can be configured for the following third configuration: the conveyor inlet is located between the work-holding platform and an end-of-travel position of the carriage, the device further comprising a displacement member distinct from the conveyor and configured to move powder removed from the carriage into the inlet.

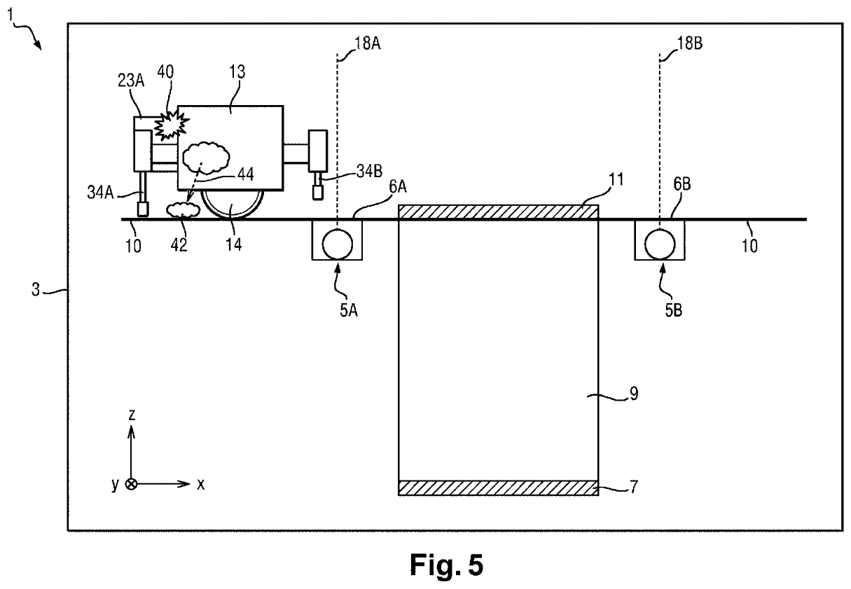

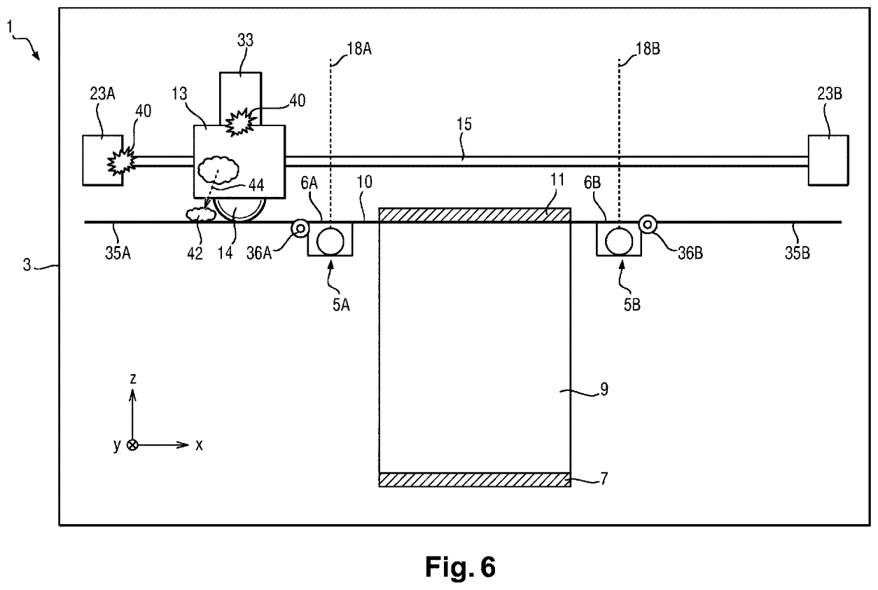

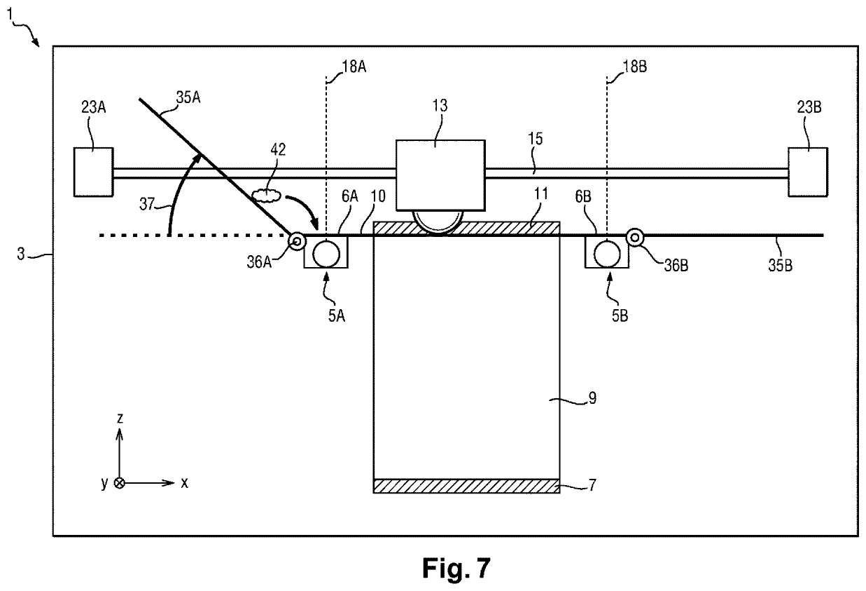

This third configuration is shown in a first variant in FIGS. 4 and 5 and in a second variant in FIGS. 6 and 7.

In this third configuration, the conveyor can be the recycling path of the delivery system 5A, 5B, as the inlets 6A, 6B have positions 18A, 18B different from the end-of-travel positions 17 and 19 of the carriage 13.

This third configuration does not require the carriage 13 to be in line with the conveyor inlet for dusting to be triggered.

This third configuration is compatible with the various embodiments of the dusting appliance described above: FIG. 4 shows the second type of dusting appliance 33, and FIG. 5 shows the first embodiment of the dusting appliance 23A.

The additive manufacturing device 1 in this third configuration comprises a displacement member 34A, 34B, 35A, 35B distinct from the conveyor and configured to move the powder removed from the carriage into the conveyor inlet.

Different embodiments of this displacement member are possible.

In a first embodiment of the displacement member shown in FIGS. 4 and 5, the member is a scraper 34A, 34B mounted on the carriage and configured to be in an active configuration wherein the scraper 34A, 34B is in contact with the bench 10 and in a passive configuration wherein the scraper is located above the bench 10.

The carriage 13 comprises the scraper 34A, 34B, which projects from the carriage 13 in the main direction. The carriage may comprise a first scraper 34A on one side and a second scraper 34B on the other side with respect to the main direction. The scraper 34A, 34B extends in the transverse direction over a length greater than or equal to the length of the carriage in this same transverse direction. The scraper 34A, 34B comprises a deformable portion which forms its lowermost part. The scraper 34 is mounted so as to be movable with respect to the carriage 33, and in particular so as to be vertically translatable along the z axis. The scraper is configured to switch from an active configuration to a passive configuration and vice versa.

In the active configuration, the scraper 34A, 34B is in a low position so that the deformable part is in contact with the bench 10.

In the passive configuration, the scraper 34A, 34B is in a raised position so that the deformable part is not in contact with the bench 10, but is above the bench 10.

The scraper can be moved vertically from the active configuration to the passive configuration by cylinders mounted on the carriage, with the scraper mounted on the cylinders.

In FIGS. 4 and 5, the carriage 13 comprises two scrapers 34A, 34B, with the scraper 34A shown in its active configuration and the scraper 34B shown in its passive configuration.

When the carriage is dusted by a jolt 40, the removed powder 42 falls onto the bench 10.

In its active configuration, the scraper is in contact with the bench 10. By setting the carriage in motion when the scraper is in its active configuration, the scraper can be moved while maintaining contact with the bench 10. It is possible to bring the scraper into contact with the removed powder and move the powder against the scraper. In this way, an intermediate powder displacement is achieved, which serves to bring the removed powder to the conveyor inlet.

It should be noted that when the additive manufacturing device comprises a displacement member in the form of a scraper 34A, 34B mounted on the carriage via cylinders, this scraper can act as a dusting appliance configured to mechanically excite the carriage and remove powder deposited on the carriage. The energy of the jolt is then generated by the cylinders of the actuator when they come to a stop.

In a second embodiment of the displacement member shown in FIGS. 6 and 7, the member is a rotatable flap 35A, 35B configured to be in an active configuration wherein the flap 35A, 35B is inclined toward the conveyor inlet and in a passive configuration wherein the flap is horizontal.

The flap 35A, 35B is comprised in the enclosure 3. The flap 35A, 35B is located adjacent to the conveyor inlet in the main direction, so that the conveyor inlet is located between the flap 35A, 35B and the work-holding platform. The flap 35A, 35B is mounted for rotation about a horizontal axis of rotation 36A, 36B. The horizontal axis of rotation is parallel to the transverse direction shown by the y axis in FIGS. 6 and 7. The axis of rotation passes through the flap 35A and is located adjacent to the conveyor inlet.

The flap 35A, 35B extends in the main direction from the horizontal axis of rotation to the stop 23A, 23B.

The flap 35A, 35B is configured to switch from an active configuration to a passive configuration and vice versa.

In the active configuration, the flap 35A, 35B is inclined with respect to the horizontal plane so that the flap 35A, 35B rises above the vertical position of the bench 10. The flap 35A, 35B is inclined toward the conveyor inlet in the sense that an object located on the upper surface of the flap is attracted by gravity toward the conveyor inlet.

In the passive configuration, the flap 35A, 35B is oriented in a horizontal plane so that an upper surface of the flap 35A, 35B lies in line with the bench 10. The carriage 13 can then move above the flap 35A, 35B and stop above it.

The device can comprise two flaps 35A, 35B, which are located on both sides of the work-holding platform when the delivery system 5A, 5B comprises two sliding trays and therefore two conveyor inlets 6A, 6B.

### Additive Manufacturing Method

An additive manufacturing device such as the one presented here enables a method according to the invention to be implemented for better control of the powder pollution generated during the powder spreading step The various steps of the method will be presented below.

In a first step, the carriage 13 is used to spread a manufacturing powder on the work-holding platform 7 in the enclosure 3.

This first step may comprise, for example:
providing a powder bead on a sliding tray of the delivery system 5A, 5B,
before providing the bead, positioning the carriage 13 so that the sliding tray is located between the work-holding platform 7 and the carriage 13,
setting the carriage 13 in motion in a spreading direction toward the sliding tray and the work-holding platform 7, so that the powder deposited on the sliding tray is carried by the member 14 of the carriage toward the work-holding platform, and
as the carriage travels along the first length of the work-holding platform, spreading the spread powder on the work-holding platform via the member 14.

In a second step, any powder undesirably covering the carriage 13 is removed. This second step is also referred to as dusting the carriage.

This second step is carried out after the first step. Advantageously, and before this second step, the carriage 13 continues its movement in the spreading direction beyond the work-holding platform. In this way, the removed powder is not deposited on the layer of powder just deposited.

The dusting appliance according to one of the previously described embodiments is triggered and produces a jolt or vibration 40 on the carriage 13 so that the powder 42 is removed from the carriage 13 according to the movement 44.

In a third step, the removed powder is
either recycled by the conveyor according to the first option mentioned above,
or kept in the storage area according to the second option mentioned above.

This third step is also referred to as the isolation of the removed powder, in the sense that the risk of pollution of the newly deposited layer by this removed powder is greatly reduced.

In all cases, the removed powder is kept away from the work-holding platform to prevent it from polluting the newly deposited layer and, more generally, the manufacturing method. Powder pollution generated during the powder spreading step is thus better controlled.

Advantageously, the last two steps described above can be carried out after each planned spreading of the powder during the manufacturing method. Alternatively, they can be performed at a lower spreading frequency, for example after each group of two successive spreading operations, or after each group of a larger number of successive spreading operations.

When the removed powder is stored in the storage area, it is advantageous for the storage area to have a volume greater than or equal to four liters. In this way, a large number of carriage dustings can be carried out before the storage area is full. This reduces the frequency of human intervention to empty the storage area.

In common with the first and second options described above, the method can be adapted in a first way so that powder removal is triggered after a step in which the carriage moves to the end of its travel, so that during powder removal, the powder removed falls by gravity into the conveyor inlet or into the storage area.

This first adaptation of the method corresponds to the first configuration of the device described above and shown in FIGS. 1 and 2.

This first adaptation corresponds to a carriage 13 which, after spreading the powder, continues its movement in the spreading direction beyond the work-holding platform to the end of travel. The powder that undesirably covers the carriage is removed as far as possible from the work-holding platform, further limiting the risk of contamination of the spread layer.

After the jolt 40 produced on the carriage 13 by the dusting appliance, the removed powder 42 falls by gravity into the conveyor inlet or into the storage area, so that there is no need to provide for intermediate movement of the powder toward the conveyor inlet or into the storage area.

When the device comprises a conveyor inlet or storage area at the end of each carriage stroke, it is possible to dust and isolate the powder removed after each passage of the carriage over the work-holding platform 7.

In connection with the abovementioned second option, the method can be adapted according to a second adaptation so that powder removal is triggered after a step in which the carriage is moved vertically level with the conveyor inlet between the work-holding platform and a carriage end-of-travel position, so that during powder removal, the powder removed falls by gravity into the conveyor inlet.

This second adaptation of the method corresponds to the second configuration of the device described above and shown in FIG. 3. This second adaptation is related to the second embodiment of the dusting appliance.

This second adaptation can be implemented with the delivery system 5A, 5B already present in the device. There is no need to add a storage area or recovery bin and a powder suction system to the device.

This second adaptation corresponds to a carriage 13 which, after spreading the powder, continues its movement in the spreading direction beyond the work-holding platform to the inlet 6A, 6B of the recycling path of the delivery system 5A, 5B. The powder which undesirably covers the carriage is removed sufficiently far from the work-holding platform to limit the risk of contamination of the spread layer in a satisfactory manner.

After the jolt 40 or vibrations produced on the carriage 13 by the dusting appliance, the removed powder 42 falls by gravity into the conveyor inlet 6A, 6B, so that there is no need to provide for intermediate movement of the powder toward the conveyor inlet.

If the device comprises an inlet to the delivery system 5A, 5B recycling path on both sides of the work-holding platform, then it is possible to dust and isolate the removed powder after each passage of the carriage over the work-holding platform 7.

Still related to the second option recalled above, and according to a third adaptation, the method can comprise, after powder removal, a step of intermediate movement of the removed powder into the conveyor inlet.

This third adaptation is shown in a first variant in FIGS. 4 and 5 and in a second variant in FIGS. 6 and 7.

This third adaptation of the method corresponds to the third configuration of the device mentioned above and shown in a first variant in FIGS. 4 and 5 and in a second variant in FIGS. 6 and 7. This third adaptation is compatible with the various embodiments of the dusting appliance described above.

This third adaptation can be implemented with the delivery system 5A, 5B already present in the device. There is no need to add a storage area or recovery bin and a powder suction system to the device.

This third adaptation does not require the carriage 13 to be positioned at a particular point in its stroke for dusting to be triggered. There is greater freedom in terms of carriage position. Furthermore, the intermediate movement step of the removed powder can be used to feed a larger quantity of removed powder to the conveyor inlet.

The first variant of the third adaptation corresponds to the case where the intermediate movement is provided by the scraper 34A, 34B mounted on the carriage 13 and configured to be in contact with the bench 10.

In this second variant, the scraper 34A, 34B is by default in its passive configuration, that is to say in a raised position so as not to come into contact with the bench 10 or the last layer of spread powder 11. In particular, during the step of spreading the powder on the work-holding platform, the scraper 34A, 34B is in its passive configuration.

Unwinding can be triggered when the carriage 13 is beyond the work-holding platform and the conveyor inlet, that is to say when the conveyor inlet is located between the carriage and the work-holding platform. It should be noted that the jolt 40 can be produced by the dusting appliance chosen in its first or second embodiment. In the first embodiment, the carriage 13 is positioned at the end of its travel before dusting is triggered. In the second embodiment, the carriage 13 is freely positioned between this end of travel and the conveyor inlet before dusting is triggered.

Once the jolt 40 has been produced on the carriage 13 by the dusting appliance, the removed powder falls by gravity onto the bench 10. The scraper 34A, 34B is placed in its active configuration. This situation is shown in FIG. 4 when the dusting appliance corresponds to the second embodiment 33, and in FIG. 5 when the dusting appliance corresponds to the first embodiment 23A.

The carriage 13 is set in motion so that the scraper 34A moves the removed powder 42 into the conveyor inlet 6A, 6B.

Once the removed powder 42 is inside the conveyor, the scraper 34A can be placed in a passive configuration.

In the case where the carriage 13 comprises two scrapers 34A, 34B on both sides of the carriage in the main direction, it is the scraper furthest from the conveyor inlet that is placed in its active configuration and used to move the removed powder into the conveyor inlet.

The second variant of the third adaptation corresponds to the case where the intermediate movement is provided by a flap 35A, 35B that can rotate and is configured to tilt toward the conveyor inlet.

In this second variant, the flap 35A, 35B is by default in its passive configuration, that is to say horizontally oriented. In particular, during the step of spreading the powder on the work-holding platform, the flap 35A, 35B is in its passive configuration.

Unwinding can be triggered when the carriage 13 is beyond the work-holding platform and the conveyor inlet, that is to say when the conveyor inlet is located between the carriage and the work-holding platform. It should be noted that the jolt 40 can be produced by the dusting appliance chosen in its first or second embodiment. In the first embodiment, the carriage 13 is positioned at the end of its travel before dusting is triggered. In the second embodiment, the carriage 13 is freely positioned between this end of travel and the conveyor inlet before dusting is triggered.

Unwinding can be triggered when the carriage 13 is located above the flap 35A, 35B, which is in its passive configuration, that is to say horizontally oriented.

Once the jolt 40 has been produced on the carriage 13 by the dusting appliance, the removed powder 42 falls by gravity onto the flap 35A, 35B. This situation is shown in FIG. 6.

The carriage 13 is then moved toward the work-holding platform so that it is no longer above the flap 35A, 35B.

The flap 35A, 35B is placed in its active configuration. This situation is shown in FIG. 7. The flap 35A rotates about the axis of rotation 36A and thus rises above the axial position of the bench 10. The flap 35A tilts at an angle 37, forming an inclined plane toward the conveyor inlet 6A. The removed powder 42 located on this inclined plane is then drawn by gravity to the bottom of the plane, that is to say into the conveyor inlet 6A.

Once the removed powder 42 is inside the conveyor, the flap 35A can be placed in the passive configuration.

It should be noted that at the end of part manufacture, some of the residual powder present on the bench, and which has for example been removed from the carriage on the bench, can be spread on the last layer of the powder bed previously lowered below the surface of the bench. This powder is then extracted from the enclosure when the work-holding platform is removed, and is then processed by a dusting machine, which frees the manufactured part from the surrounding unconsolidated powder.

1. An additive manufacturing device comprising an enclosure and a conveyor configured to recirculate manufacturing powder, the enclosure comprising:
a work-holding platform,
a carriage configured to spread powder on top of the work-holding platform,
a dusting appliance included in the carriage and configured to trigger a jolt or a vibration in the carriage and remove powder from the carriage; and
an inlet of the conveyor,
the device being configured to feed removed powder from the carriage into the inlet of the conveyor the inlet being located between the work-holding platform and an end-of-travel position of the carriage.

2. The device according to claim 1 configured to feed removed powder from the carriage into the inlet of the conveyor, the device further comprising a displacement member distinct from the conveyor and configured to move the removed powder from the carriage into the inlet.

3. The device according to claim 2, wherein the displacement member is a scraper mounted on the carriage and configured to be in an active configuration wherein the scraper is in contact with the bench in the enclosure and in a passive configuration wherein the scraper is located above the bench.

4. The device according to claim 2, wherein the displacement member is a rotatable flap configured to be in an active configuration wherein the flap is inclined toward the conveyor inlet and in a passive configuration wherein the flap is horizontal.

5. An additive manufacturing method comprising the following steps:
by means of a carriage spreading a production powder on a work-holding platform within an enclosure,
removing powder from the carriage by triggering a jolt or vibration in the carriage by a dusting appliance included in the carriage, and
recycling the removed powder by a conveyor an inlet of the conveyor being located between the work-holding platform and an end-of-travel position of the carriage, powder removal.

6. The method according to claim 5, wherein powder removal is triggered after a step wherein the carriage is moved in line with the inlet, so that when the powder is removed, the removed powder falls by gravity into the inlet of the conveyor.

7. The method according to claim 5, comprising, after powder removal, a step of intermediately moving the removed powder into the conveyor inlet.

8. The method according to claim 7, wherein the intermediate movement is provided by a scraper mounted on the carriage and configured to be in contact with a bench.

9. The method according to claim 7, wherein the intermediate movement is provided by a flap that can rotate and is configured to tilt toward the conveyor inlet.
